(19) United States
(12) Patent Application Publication
(10) Pub. No.: US 2013/0130147 A1
(43) Pub. Date: May 23, 2013

(54) FUEL CELL STACK

(71) Applicant: SAMSUNG SDI CO., LTD., Yongin-si (KR)

(72) Inventors: Tae-Ho Kwon, Yongin-si (KR); Hyun Soh, Yongin-si (KR); Kwang-Jin Park, Yongin-si (KR)

(73) Assignee: SAMSUNG SDI CO., LTD., Yongin-si (KR)

(21) Appl. No.: 13/657,373

(22) Filed: Oct. 22, 2012

(30) Foreign Application Priority Data
Nov. 23, 2011 (KR) 10-2011-0122870

(51) Int. Cl. H01M 8/24

(52) U.S. Cl. 429/469

(57) ABSTRACT

A fuel cell stack providing a connection between a current collector and a plurality of unit cells. The fuel cell stack includes a plurality of unit cells deposed to extend in parallel along a first direction and to be electrically connected to each other; a support arranged to extend along a second direction crossing the first direction; and a current collector connected to the support via a fastener, the fastener comprising a metal layer and a metal oxide layer. Here, the metal oxide layer is formed to have a set or predetermined thickness on the surface of a metal layer of the fastener to provide an improved connection of the unit cells and the current collector.

### CROSS-REFERENCE TO RELATED APPLICATION

This application claims priority to and the benefit of Korean Patent Application No. 10-2011-0122870, filed in the Korean Intellectual Property Office on Nov. 23, 2011, the entire content of which is incorporated herein by reference.

### BACKGROUND

1. Field

The invention relates to a fuel cell stack.

2. Description of Related Art

A solid oxide fuel cell (SOFC) operates at a high temperature of about 600° C. to 1000° C. and is more efficient and less polluting as compared with other types of fuel cells.

In addition, a solid oxide fuel cell does not require a fuel reformer and has an advantage of providing a multi-application electricity generation.

Since a solid oxide fuel cell has a low voltage, it is usually formed into a stack by connecting a plurality of unit cells in order to obtain a high voltage.

In this case, a fuel cell stack is pressurized and accommodated by current collector plates including a support member and a fastener tightened with the support.

### SUMMARY

An aspect of an embodiment of the present invention is directed toward an improved fastener for a fuel cell.

An aspect of an embodiment of the present invention is directed toward the formation of a metal oxide layer having a set or predetermined thickness on a surface layer of a metal layer to increase a clamping force between a fastener connecting a support, thereby providing a fuel cell stack with an improved connection between one or more unit cells and a current collector (e.g., current collector plates).

In addition, an aspect of an embodiment of the present invention is directed toward a fuel cell stack form to have a groove portion between a current collector (current collector plate) and the unit cell to securely clamp the unit cell to the current collector.

A fuel cell stack according to an embodiment of the present invention includes a plurality of unit cells deposed to extend in parallel along a first direction and to be electrically connected to each other; a support arranged to extend along a second direction crossing the first direction; and a current collector connected to the support via a fastener, the fastener comprising a metal layer and a metal oxide layer.

In one embodiment, the metal oxide layer is formed to surround a surface of the metal layer.

In one embodiment, a thickness of the metal oxide layer is in a range of 0.05 mm to 0.15 mm.

In one embodiment, the metal layer is composed of titanium, nickel, molybdenum, cobalt, tungsten, manganese, silicon, chromium, or an alloy thereof.

In one embodiment, the support is accommodated into a through-hole formed in the current collector.

In one embodiment, the fuel cell stack further includes an insulating member deposed adjacent to the fastener and connected to the support. Here, the fastener may be on a surface of the current collector and interposed between an end portion of the support and the insulating member.

In one embodiment, a cross-section in a longitudinal direction of the support is in a T shaped bolt form or a rivet form.

In one embodiment, the fastener includes a nut.

In one embodiment, a clamping force applied between the interconnected support and the fastener is in a range of 0.1 Nm to 0.3 Nm at room temperature.

In one embodiment, the fastener includes a washer.

In one embodiment, the first direction is a gravity direction.

In one embodiment, each of the unit cells includes a first electrode and a connection formed along a longitudinal direction of the first electrode, the connection protruding out from an outer peripheral surface of the first electrode; and a current collector member is connected to at least a neighboring one of the unit cells and the connection.

In one embodiment, the current collector further includes a groove portion corresponding to the connection.

In one embodiment, the fuel cell stack further includes a housing accommodating at least one end of the unit cells.

An embodiment of the present invention forms the metal oxide layer having a set or predetermined thickness on a surface of the metal layer of the fastener to increase a clamp force between the support and the fastener connected to the support, thereby improving a connection between the unit cells and the current collector.

In one embodiment, the fuel cell stack is formed to have a groove portion between the current collector (e.g., the current collector plate) and the unit cell to further securely clamp the unit cells to the current collector.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a combined perspective view showing a fuel cell stack according to an embodiment of the present invention.

FIG. 2 is a cross-section taken along A-A′ of FIG. 1.

FIG. 3 is a combined perspective view showing a current collector connected to a support according to an embodiment of the present invention.

FIG. 4 is a cross-section taken along B-B′ of FIG. 3.

FIG. 5 is a combined perspective view showing a current collector connected to a support according to another embodiment of the present invention.

FIG. 6 is a graph showing an interval between the metal plates and the difference value thereof according to a clamping force of an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

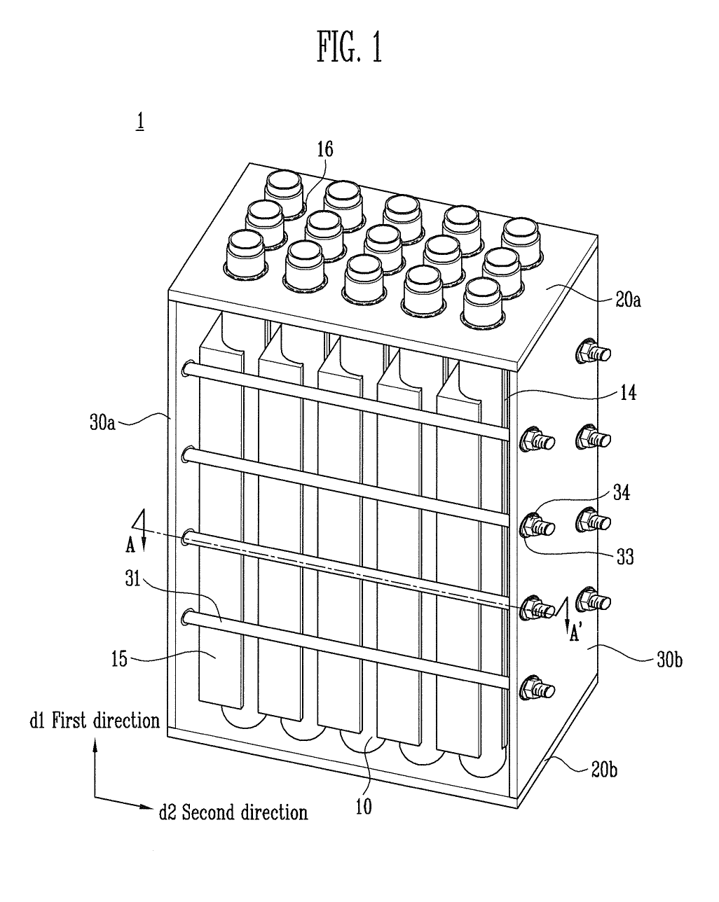

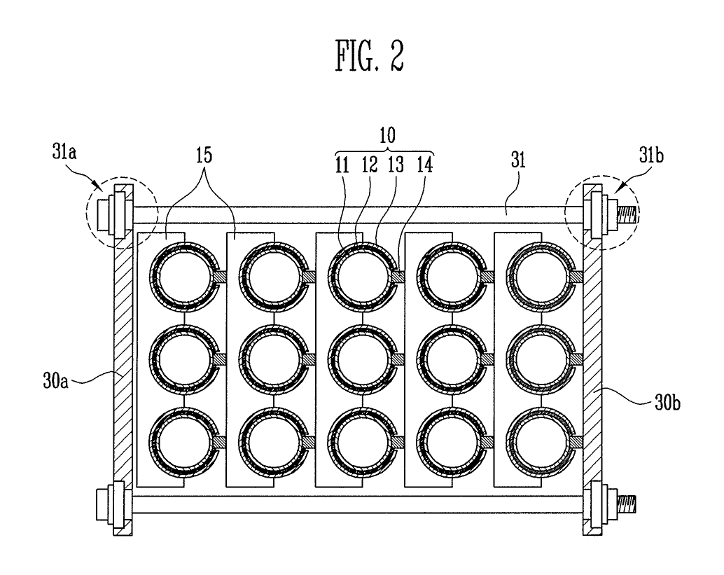

FIG. 1 is a combined perspective view showing a fuel cell stack (a fuel electrode stack) according to an embodiment of the present invention, and FIG. 2 is a cross-section taken along line A-A′ of FIG. 1.

Referring to FIGS. 1 and 2, the fuel cell stack 1 includes a plurality of unit cells 10 deposed along a first direction d1 parallel with a longitudinal direction of the fuel cell stack 1 such that the unit cells 10 are electrically connected to each other; a support 31 arranged along a second direction d2 crossing (e.g., perpendicular to) to the first direction d1; and a current collector 30 (current collector plates 30a, 30b) with a fastener 34 (or 33) connected to the support 31.

In operation, an electric and chemical reaction is generating in the fuel cell stack 1. Here, each of the unit cells 10 of the fuel cell stack 1 is shown to have a cylindrical shape (shown to be a cylindrical solid oxide fuel cell), but the present invention is not thereby limited.

Also, as shown in FIG. 2, hydrogen supplied through a first electrode 11 (which is a fuel electrode of the cylindrical unit cell 10) and oxygen supplied through a second electrode 13 (which is an air cathode) electrically and chemically react to produce electrons.

The electrons produced in such a way iterate a process by moving to the adjacent unit cell 10 through a band-shaped connection 14 and a current collector member 15 to generate electricity and heat.

That is, one unit cell 10 may be formed to obtain a voltage generated by the first electrode 11 and the second electrode 13. Here, the connection 14 is electrically connected to the second electrode 13 to provide interconnection with other unit cells 10, and an electric and chemical reaction is generated by supplying fuel gas to the electrode 13 (which is a fuel electrode formed in an internal part of a cylinder of the one unit cell 10) and by supplying air to the second electrode 13 (which is an air cathode formed in the outer peripheral portion of the cylinder).

Each component of the stack of the fuel electrode will described below in more detail.

First, the plurality of unit cells 10 are composed of fifteen cells of 5S3P(5 serials-3 parallel) and are formed to be electrically connected by the current collector member 15.

Herein, each unit cell 10 may include a tube shape first electrode 11 having a hollow tubular opening, a connection 14 formed along the longitudinal direction of the first electrode 11 to protrude out of the outer peripheral surface of the first electrode 11, an electrolyte layer 12 formed on the outer peripheral layer of the first electrode 11 except at the connection 14, and a second electrode 13 formed not to contact the connection 14 and to be the outer peripheral surface of the unit cell 10. In addition, the upper portion of the unit cell 10 has a closed (sealed) form.

The first electrode 11 and the second electrode 13 will be described as a fuel electrode and an air cathode for convenience of the following description, receptively. However, in another embodiment, the electrode 11 and the second electrode 13 can be formed as the air cathode and the fuel electrode, respectively.

The plurality of the unit cells 10 are supported structurally by the current collector member 15 and are electrically connected to each other via the current collector member 15. The current collector member 15 is deposed between the adjacent unit cells 10 so that each unit cell 10 is deposed in a set or predetermined space.

In one embodiment, when viewing from one column, one current collector member 15 is commonly contacted (connected) to all the second electrodes 13 (which are the air cathodes formed in the outer peripheral surfaces of the unit cells) along that column so that the unit cells along that column are connected in parallel.

In addition, the current collector member 15 contacts the connections 14 connected to the first electrodes 11 of another three unit cells 10 along another column in series. Here the first electrodes 11 are the fuel electrodes of the other three unit cells 10.

Therefore, the current collector member 15 can electively connect the unit cells 10 as 5S3P(5 serials-3 parallel).

A first housing 20a is formed to have a plurality of holes 10a formed at positions corresponding to the plurality of unit cells 10, and one end portion of each of the unit cells 10 is inserted to pass through a corresponding one of the holes 10a.

Herein, a sealing material 16 to seal the hole 10a may be formed at the one end portion of the unit cell 10 exposed out from the internal portion of the first housing 20a and the boundary of the first housing 20a.

Moreover, the housing 20b is provided with concaves for receiving the other ends of the unit cells 10, and each of the concaves is configured at the other end to receive and support a corresponding one of the unit cell having the closed or sealed form.

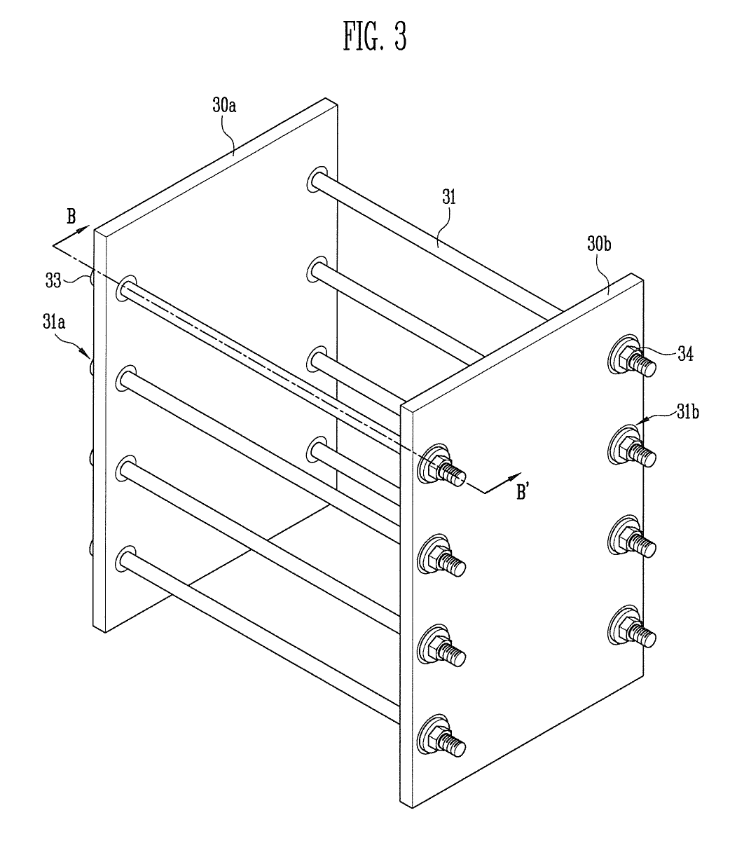

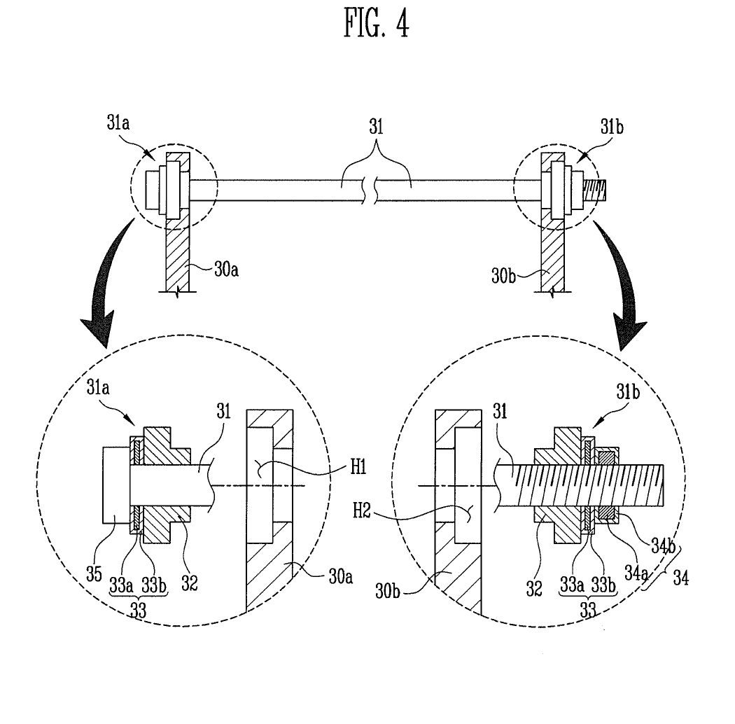

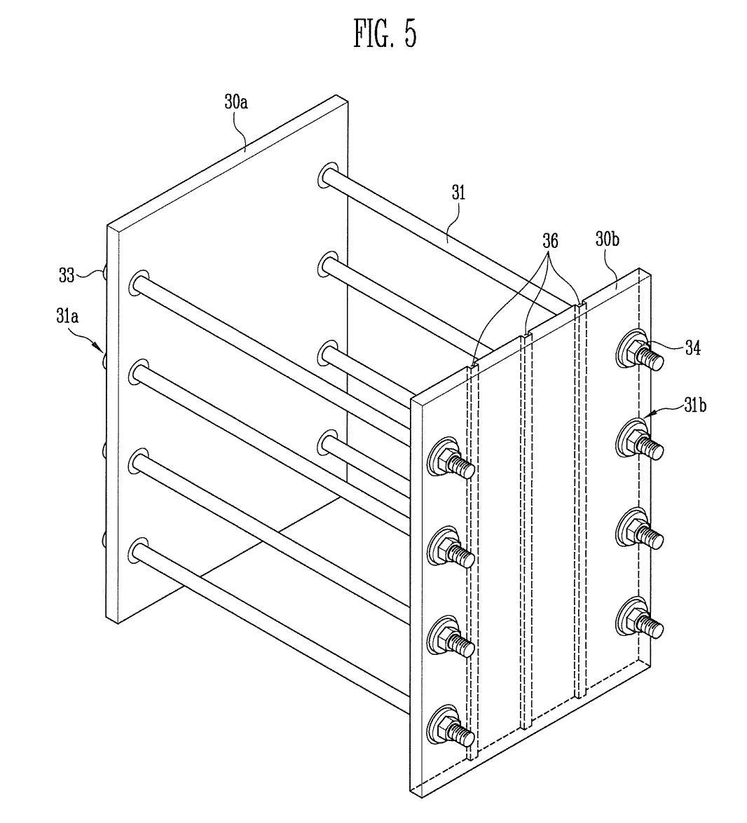

FIG. 3 is a combined perspective view showing a current collector connected to a support according to an embodiment of the present invention. FIG. 4 is a cross-section taken along B-B′ of FIG. 3. FIG. 5 is a combined perspective view showing a current collector connected to a support according to another embodiment of the present invention.

A plurality of the units 10 formed to have the above-mentioned configuration are deposed to extend along a first direction (d1), which is a gravity direction.

In addition, a plurality of supports 31 adjacent to the plurality of the unit cells 10 are arranged spaced apart from each other and to extend along a second direction d2 crossing the first direction d1.

Herein, an end portion at one end of each of the plurality of supports 31 is received at a first current collector 30a and passes through a corresponding through-hole (H1) of the current collector 30a.

The through-hole H1 is provided with an insulation member 32 connected with the support 31 (which is adjacent to a fastener 33), and the one end portion (31a) of the support 31 exposed to the outside of the first current collector 30a is combined with the fastener 33.

Herein, the longitudinal cross-section of the one end portion 31a of the support 31 may have a T shape (e.g., be a T shaped bolt 35) and/or be in a rivet form.

Therefore, the fastener 33 is formed on the surface of first current collector 30a and is interposed between the one end portion 31a of the support 31 and the insulation member 32.

As with the one end portion 31a of the support 31, the other end portion 31b of the support 31 is also combined or interconnected.

However, since the other end portion 31b of the support 31 is in the common rod form rather than a bolt or a rivet form as in the one end portion 31a, the other end portion 31b of the support 31 is combined with a fastener 34 composed of a nut connected to the support 31.

Moreover, the second current collector 30b of the current collector 30 according to FIG. 5 is provided with one or more groove portions 36 corresponding to the one or more connections 14.

Since the connection 14 corresponds to the groove portion 36 that is provided to the second current collector 30b in the embodiment shown in FIG. 5, the connection between the current collector 30 and the plurality of the unit cells 10 is enhanced.

The fastener 33 according to an embodiment of the present embodiment is in a washer form so that the support 31 can pass through.

The fastener 33 is composed of the metal layer 33a and the metal oxide layer 33b formed to surround the surface of the metal layer 33a.

The metal layer 33a is composed of any one or any alloy of titanium, nickel, molybdenum, iron, cobalt, tungsten, manganese, silicon and chrome. Here, one limitation of the metal of the metal layer 33a will be that the metal layer 33a has to be composed of a metal that can form the metal oxide layer 33b on the surface of the metal layer 33a.

For example, the metal layer 33a can be composed of Haselloy formed of an alloy composed of at least two of nickel, chromium, iron, cobalt, tungsten, manganese, and silicon; or be composed of Inconel formed of an alloy composed of at least two of nickel, chromium, molybdenum, and iron.

Herein, in one embodiment, the thickness of the metal oxide layer 33b formed on the surface of the metal layer 33a is in a range of 0.05 mm to 0.15 mm.

The thickness of the metal oxide layer 33b, criticality significance applied between the support 31 and the fastener 33, and the manufacturing method of envisioned structures capable of obtaining the above-mentioned results will be described as follows.

### Embodiment 1

Embodiment 1 will describe the relationship between a thickness of a metal oxide layer 33b in a fuel cell stack 1 of unit cells 10 and a clamping force applied between a support 31 and a fastener 33.

Two through-holes were formed in two same metal plates to form the current collectors according to an embodiment of the present invention. Here each of the metal plates (current collectors 30a and 30b) has a size of 5 cm×3 cm×1 mm.

Nickel structure (e.g., a nickel foam structure) used to form the current collector member 15 according to an embodiment of the present invention was disposed between the two metal plates (the two current collectors 30a and 30b).

A same insulation plate as the insulation member 32 according to an embodiment of the present invention is provided, and the same one end portion 31a (with the T shaped bolt 35) of the support 31 according to an embodiment of the present invention is disposed to pass through the through-hole.

In addition, the same fastening washer (fastening plate) as the fastener 33 of an embodiment of the present invention was combined by a 1 Nm controlled torque wrench and the same fastening nut as the fastener 34 of an embodiment of the present invention was combined with the other end portion 31b of the support 31 (which is a rod) by a 1 Nm controlled torque wrench.

The embodiment used the fastener composed of chromium, manganese, iron or alloy thereof. Herein, The torque wrench is a tool used when a bolt and nut is tightened based on a set or predetermined torque (rotating force) wherein the torque which a user wants can be easily applied to the bolt and nut through the scale provided with the inner portion thereof.

The metal oxide layer 33b composed of metal of the fastener 33 according to the present invention is formed at a high temperature in a range of 800° C. to 1000° C.

Here, the thickness of the metal oxide layer 33b formed on the surface of the metal layer 33a in the high temperature range may be difficult to determine.

In this way, in the embodiment, the difference value of the reduced interval between the two metal plates varying based on the degree of the fastening pressure applied to the fasteners by a torque wrench in high temperature was measured.

TABLE 1

| Fastening | Interval | Difference |
|---|---|---|
| pressure (Nm) | (mm) | value (mm) |
| 0.4 | 19.37 | |
| 0.5 | 19.1 | 0.27 |
| 0.6 | 18.65 | 0.45 |
| 0.7 | 18.57 | 0.08 |
| 0.8 | 18.24 | 0.33 |
| 0.9 | 18.11 | 0.13 |
| 1.0 | 18.05 | 0.06 |
| 1.1 | 17.99 | 0.06 |
| 1.2 | 17.94 | 0.05 |
| 1.3 | 17.90 | 0.04 |
| 1.4 | — | — |

Referring to table 1, if the fastening pressure of less than 1.0 Nm is applied to the metal plate, the interval difference between the two metal plates is relatively larger than if the fastening pressure of more than 1.0 Nm is applied.

In addition, if the fastening pressure of 1.4 Nm is applied, the metal plate breaks, so that the interval between the metal plates cannot be measured.

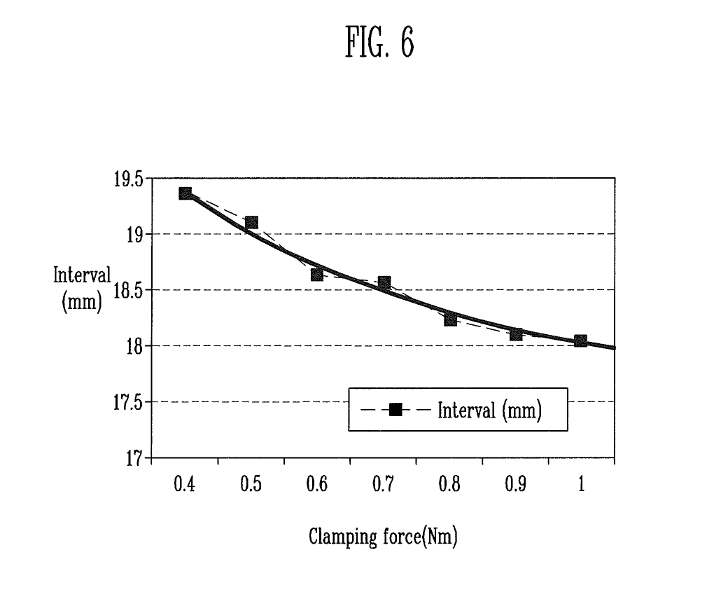

Referring to FIG. 6, considering the trend of the interval between two metal plates according to fastening application, if the fastening pressure of less than 1.0 Nm is applied to the metal plate through the fastener as shown in the horizontal axis of FIG. 6, the difference value of the interval as shown in the vertical axis of FIG. 6 is relatively larger than if the fastening pressure of more than 1.0 Nm is applied, and the tilt of the solid trend line shown in FIG. 6 is relatively large.

Also, if the fastening pressure of more than 1.0 Nm is applied to the metal plate through the fastener as shown in the horizontal axis, the difference value shown in the vertical axis is relatively smaller than if the fastening pressure is less than 1.0 Nm, and the tilt of the solid trend line in FIG. 6 is relatively small.

This can be estimated that even if the same degree of the fastening pressure is applied to the metal plate, the reduced degree between the two metal plates becomes small; and the nickel foam structure interposed between the two metal plates may even be contracted.

In addition, the oxide layer may be formed as a thickness corresponding to a length corresponding to the difference in value of the interval between the two metal plates after applying the interval and the fastening pressure between the two metal plates prior to applying the fastening pressure.

In this way, if the relationship of the thickness of the metal oxide layer according to the fastening pressure application is known, the clamping force applied to the fasteners through the thickness of the metal oxide layer formed in high temperature may be determined.

For reference, in fact, the clamping force providing basic defect for a drive of the fuel cell stack is at a torque of about 1.0 Nm.

In table 1 and FIG. 6, the clamping force that the nickel foam structure interposed between the two metal plates is almost contracted and it is estimated that the increased contraction is difficult at a torque from 1.1 Nm to 1.3 Nm.

Therefore, in fact, it is estimated that the clamping force applied to the metal plate through the fastener is in a range of 0.1 Nm to 0.3 Nm at room temperature.

Since the interval (17.90 mm) between the metal plates when the clamping force of 0.3 Nm is applied is the difference value between an interval (18.05 mm) between the metal plates when the basis combination is impossible and 0.15 nm, it can be determined that the thickness of the metal oxide layer to be formed is 0.15 mm, and the thickness of the metal oxide layer to be formed is 0.05 mm when the clamping force is 0.1N through the mathematical calculations to the clamping force.

### Embodiment 2

In Embodiment 2, a structure substantially the same as the fuel electrode stack 1 according to an embodiment of the present invention is formed at an oven temperature of 800° C. and kept for a set or predetermined time.

In such a way, it was determined whether the measured thickness of the metal oxide layer formed on the surface of the nut, which is a fastening plate, belongs to the thickness range of the metal oxide layer or not.

At the same time, the thickness of the metal oxide layer was measured according to the time the formed structure was in the oven, so that operating time adapted to form the metal oxide layer was determined.

The thickness change of the metal oxide layer according the time heating of the formed structure in the oven is described below.

TABLE 2

| Temperature | Heaping | Thickness of metal | |
|---|---|---|---|
| (° C.) | time (min) | oxide layer (mm) | Note |
| 800 | 120 | 0.03 | Fastening plate (nut) |
| 800 | 120 | 0.035 | Fastening plate |
| | | | (washer) |
| 800 | 4000 | 0.035 | Fastening plate (nut) |

Referring to table 2, when the structures that various formed stacks 1 of the fuel cell according to the present invention are heated (kept) in the oven in which the temperature is maintained at 800° C. for 120 minutes, the thickness of the metal oxide layer is 0.03 mm if the fastening is a nut, and 0.035 mm if the fastening plate is a washer.

Even if the heating time remarkably increases compared to a comparable art, when the fastening plate is the nut, the increase in the thickness of the metal oxide layer was slight compared to when the thickness (0.035 mm) of the metal oxide layer is heated in the oven for 120 minutes.

If the formed structure of the stack 1 of the fuel cell is heated (kept) in the oven maintained at 800° C. for 120 minutes, it can be determined that the desired thickness of the metal oxide layer can be obtained.

In addition, if the formed structure is heated from room temperature at a fast-rate, the formed structure itself may break in whole or in part or may have a leak so that it is desired that the heat be increased at a rate of 0.5° C./min to 2° C./min.

On the other hand, in the embodiment, the formed structure of the stack 1 of the fuel cell is provided as fastening plates with two washers connected adjacent to two metal plates (which are current collectors) and the one nut disposed adjacent to one of the two washers.

Therefore, the sum of the thickness (0.03 mm) of the metal oxide layer formed in the nut surface and the thickness (2×0.035 mm) of the metal oxide layer formed in two washer surfaces is 0.1 mm of the metal oxide layer formed in the entire formed structure.

Therefore, it could be confirmed that the thickness of the metal oxide layer formed in the formed structure ranges from 0.05 mm to 0.15 mm that is the range determined for the metal oxide layer.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A fuel cell stack comprises:
a plurality of unit cells deposed to extend in parallel along a first direction and to be electrically connected to each other;
a support arranged to extend along a second direction crossing the first direction; and
a current collector connected to the support via a fastener, the fastener comprising a metal layer and a metal oxide layer.

2. The fuel cell stacks of claim 1, wherein the metal oxide layer is formed to surround a surface of the metal layer.

3. The fuel cell stack of claim 1, wherein, a thickness of the metal oxide layer is in a range of 0.05 mm to 0.15 mm.

4. The fuel cell stack of claim 1, wherein, the metal layer is composed of titanium, nickel, molybdenum, cobalt, tungsten, manganese, silicon, chromium, or an alloy thereof.

5. The fuel cell stack of claim 1, wherein, the support is accommodated into a through-hole formed in the current collector.

6. The fuel cell stack of claim 1, further comprising an insulating member deposed adjacent to the fastener and connected to the support.

7. The fuel cell stack of claim 6, wherein, the fastener is on a surface of the current collector and interposed between an end portion of the support and the insulating member.

8. The fuel cell stack of claim 1, wherein, a cross-section in a longitudinal direction of the support is in a T shaped bolt form or a rivet form.

9. The fuel cell stack of claim 1, wherein the fastener comprises a nut.

10. The fuel cell stack of claim 1, wherein, a clamping force applied between the interconnected support and the fastener is in a range of 0.1 Nm to 0.3 Nm at room temperature.

11. The fuel cell stack of claim 1, wherein, the fastener comprises a washer.

12. The fuel cell of claim 1, wherein, the first direction is a gravity direction.

13. The fuel cell stack of claim 1, wherein, each of the unit cells comprises a first electrode and a connection formed along a longitudinal direction of the first electrode, the connection protruding out from an outer peripheral surface of the first electrode, and wherein a current collector member is connected to at least a neighboring one of the unit cells and the connection.

14. The fuel cell stack of claim 1, wherein, the current collector further includes a groove portion corresponding to the connection.

15. The fuel cell stack of claim 1, further comprising a housing accommodating at least one end of the unit cells.

16. The fuel cell stack of claim 1, wherein the fastener comprises a nut at one end of the support and a washer at another end of the support.

17. The fuel cell stack of claim 16, wherein the washer comprises the metal layer and the metal oxide layer.

18. The fuel cell stack of claim 17, wherein the metal oxide layer surrounds a surface of the metal layer.

19. The fuel cell stack of claim 18, wherein a thickness of the metal oxide layer is in a range of 0.05 mm to 0.15 mm.

20. The fuel cell stack of claim 1, wherein the metal oxide layer is an oxide of the metal of the metal layer.
